(19) United States
(12) Patent Application Publication
(10) Pub. No.: US 2008/0077793 A1
(43) Pub. Date: Mar. 27, 2008

(54) APPARATUS AND METHOD FOR HIGH THROUGHPUT NETWORK SECURITY SYSTEMS

(75) Inventors: Teewoon Tan, Roseville (AU); Anthony Place, Waterloo (AU); Darren Williams, Newtown (AU); Robert Matthew Barrie, Double Bay (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., East Sidney (AU)

(21) Appl. No.: 11/859,530

(22) Filed: Sep. 21, 2007

Related U.S. Application Data
(60) Provisional application No. 60/826,519, filed on Sep. 21, 2006.

(51) Int. Cl. H04L 9/06

(52) U.S. Cl. 713/168

(57) ABSTRACT

An accelerated network security system includes, in part, a network security engine and a processing module configured to perform network security functions. The network security engine includes an input module configured to receive input data and generate an intermediate data in response, a core engine configured to perform security function operations on the first intermediate data to generate a first output data, and an output module configured to receive the first output data and generate a processed output data in response. The processing module includes a multitude of processing cores configured to operate concurrently, a memory configured to store processing core instructions and processing core data associated with the multitude of processing cores, and a processing controller configured to periodically allocate to each processing core one or more discrete blocks of processing time. The number of processing core data is greater than the number of processing cores.

### CROSS-REFERENCES TO RELATED APPLICATIONS

The present application claims benefit under 35 USC 119(e) of U.S. provisional application No. 60/826,519, filed Sep. 21, 2006, entitled “Apparatus And Method For High Throughput Network Security Systems”, the content of which is incorporated herein by reference in its entirety.

The present application is also related to the following U.S. patent applications, the contents of all of which are incorporated herein by reference in their entirety:

application Ser. No. 11/291,524, Attorney Docket No. 021741-001810US, filed Nov. 30, 2005, entitled “Apparatus and Method for Acceleration of Security Applications Through Pre-Filtering”;

application Ser. No. 11/465,634, Attorney Docket No. 021741-001811US, filed Aug. 18, 2006, entitled “Apparatus and Method for Acceleration of Security Applications Through Pre-Filtering”;

application Ser. No. 11/291,512, Attorney Docket No. 021741-001820US, filed Nov. 30, 2005, entitled “Apparatus and Method for Acceleration of Electronic Message Processing Through Pre-Filtering”;

application Ser. No. 11/291,511, Attorney Docket No. 021741-001830US, filed Nov. 30, 2005, entitled “Apparatus and Method for Acceleration of MALWARE Security Applications Through Pre-Filtering”;

application Ser. No. 11/291,530, Attorney Docket No. 021741-001840US, filed Nov. 30, 2005, entitled “Apparatus and Method for Accelerating Intrusion Detection and prevention Systems Using Pre-Filtering”; and

application Ser. No. 11/459,280, Attorney Docket No. 021741-003300US, filed Jul. 21, 2006, entitled “Apparatus and Method for Multicore Network Security Processing”.

### BACKGROUND OF THE INVENTION

The present invention relates generally to the area of network security. More specifically, the present invention relates to systems and methods for processing data using network security systems.

Networked devices are facing increasing security threats. Network security systems are designed to mitigate these threats. Network security systems include anti-virus, anti-spam, anti-spyware, intrusion detection, and intrusion prevention systems. Each network security system includes one or more network security engines that perform the bulk of network security functions. The amount of network traffic is increasing at a rapid rate. This trend coupled with the ever increasing numbers of security threats has the effect of putting network security systems under increasingly high computational loads, and thus reducing the processing throughputs of these systems. High throughput rates are essential for network security systems to operate effectively. What is required is an apparatus and method for improving the processing throughput of network security systems.

### SUMMARY OF THE INVENTION

In accordance with one embodiment of the present invention, an accelerated network security system includes, in part, a network security engine and a processing module configured to perform network security functions. The network security engine, includes, in part, an input module, a core engine and an output module. The input module is configured to receive input data and generate an intermediate data in response. The core engine is configured to perform security function operations on the first intermediate data to generate a first output data. The output module is configured to receive the first output data and generate a processed output data in response. The processing module includes, in part, a multitude of processing cores configured to operate concurrently, a memory and a processing controller. The memory is configured to store data associated with the multitude of processing cores. The data stored in the memory includes processing core instructions and processing core data. The processing core instructions control the execution of the multitude of processing cores to implement the security function. The processing controller is configured to periodically allocate to each processing core one or more discrete blocks of processing time according to a processing time allocation algorithm. Each portion of core data is represented by a thread of execution. The number of processing core data is greater than the number of processing cores.

In one embodiment, the core engine is configured to perform a security function on the first intermediate data using one or more processing channels. Each of the one or more processing channels may be configured to use the processing module to perform at least part of the security function. In one embodiment, the processing channels use the processing module via at least a channel data scheduler. In one embodiment, the processing module is an integrated circuit comprising a graphics processing unit. In another embodiment, the processing module is a stream processing device. In one embodiment, the processing module includes at least four processing cores. In one embodiment, at least one of the multitude of processing cores includes an arithmetic logic unit.

In one embodiment, the processing time allocation algorithm maximizes amount of data that is transferred between the multitude of processing cores and the memory over a given time period. In another embodiment, the processing time allocation algorithm maximizes utilization of the multitude of processing cores. In one embodiment, the multitude of processing cores include pixel shaders in a graphics processing unit. In another embodiment, the multitude of processing cores include vertex shaders in a graphics processing unit. In one embodiment, the multitude of processing cores are disposed in a central processing unit.

In one embodiment, the core engine is configured to perform at least one of the following security function operations, namely, pattern matching operations, regular expression matching operations, string literal matching operations, decoding operations, encoding operations, compression operations, decompression operations, encryption operations, decryption operations, and hashing operations.

In one embodiment, the multitude of processing cores are configured to perform at least one of the following operations, namely floating point operations, integer operations, mathematical operations, bit operations, branching operations, loop operations, logic operations, transcendental function operations, memory read operations, and memory write operations.

### BRIEF DESCRIPTION OF THE DRAWINGS

FIG. 1 is an exemplary block diagram of an accelerated network security system, in accordance with one embodiment of the present invention.

FIG. 2 is an exemplary block diagram of the core engine of FIG. 1, FIG. 4 illustrates the flowchart of the process of operating a network security engine at high throughput rates.

FIG. 3 is an exemplary flowchart of steps operated by the multicore processing module of FIG. 1, in accordance with one embodiment of the present invention.

FIG. 4 is a flowchart showing a process of operating a network security engine at high throughput rates, in accordance with one embodiment of the present invention.

FIG. 5 shows a number of operations associated with one of the steps of the flowchart of FIG. 4, in accordance with one embodiment of the present invention.

### DETAILED DESCRIPTION OF THE INVENTION

According to the present invention, techniques for operating network security systems at high speeds are provided. More specifically, the invention provides for methods and apparatus to operate network security systems using a multicore processing module. Merely by way of example, network security systems include anti-virus filtering, anti-spam filtering, anti-spyware filtering, anti-malware filtering, unified threat management (UTM), intrusion detection, intrusion prevent and data filtering systems. Related examples include XML-based, VoIP filtering, and web services applications. Central to these network security systems are one or more network security engines that perform network security functions. Network security functions are operations such as:
Scanning of e-mail messages for malware using a database of signatures;
Scanning of e-mail messages for spam using a database of signatures;
Scanning “http” traffic for malware using a database of signatures;
Pattern matching operations, such as those implemented using regular expressions, hashing, approximate pattern matching based on ‘edit distances’, content addressable memories, ternary content addressable memories, operations in transform domains (such as the frequency domain), discrimination functions, neural networks, support vector machines, learning machines, kernel machines, distance functions and table lookups;
Regular expression matching operations, such as those implemented using deterministic and/or non-deterministic finite automatons;
String literal matching operations, such as those implemented using deterministic and/or non-deterministic finite automatons;
Decoding operations, such as Base64 and QP decoding;
Encoding operations, such as Base64 and QP encoding;
Compression operations, such as LZW compression;
Decompression operations, such as LZW decompression;
Encryption operations, such as the class of symmetric and asymmetric encryption operations;
Decryption operations, such as the class of symmetric and asymmetric decryption operations; and
Hashing operations creating compressed representations of data that can then be efficiently used in search operations. Merely by way of example, hash operations include MD5 and SHA1. For example:
   Creating MD5 or other hash-based signatures (including “fuzzy” hash signatures) of e-mail messages to compare against a database of MD5 signatures of malware;
   Creating MD5 or other hash-based signatures (including “fuzzy” hash signatures) of e-mail messages to compare against a database of MD5 signatures of spam messages;
   Creating MD5 or other hash-based signatures (including “fuzzy” hash signatures) of “http” traffic to compare against a database of MD5 signatures of malware.

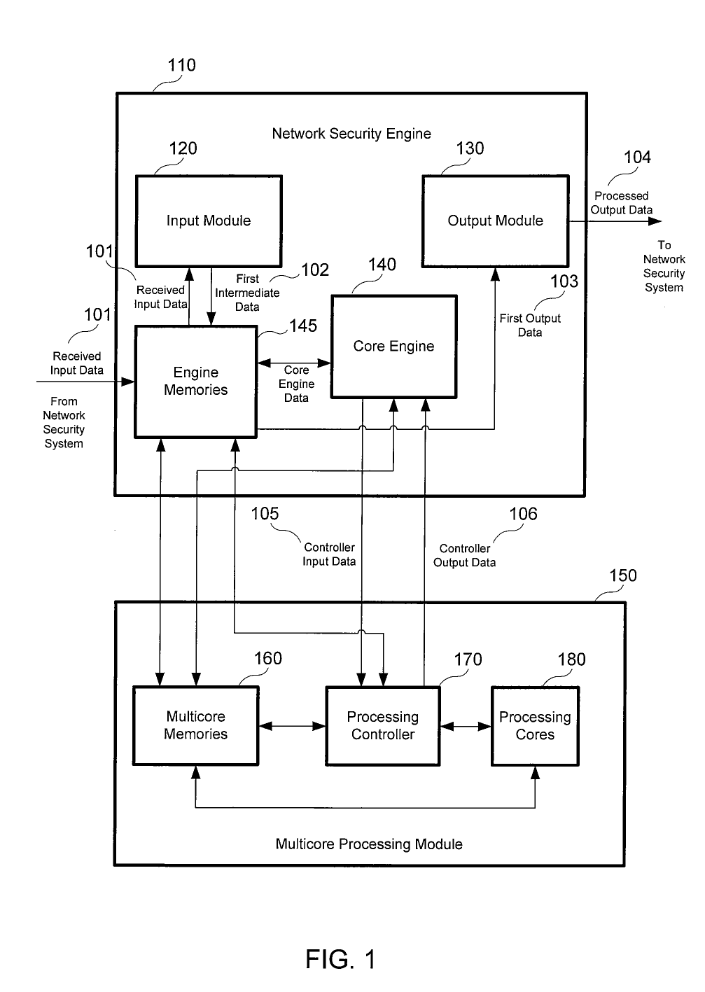

The present invention discloses an apparatus for high throughput network security systems using multicore processing modules. As shown in FIG. 1, a multicore processing module 150 includes multicore memories 160, a processing controller 170 and processing cores 180. Processing cores 180 are coupled to the multicore memories 160, and coupled to the processing controller 170. Additionally, the processing controller 170 is coupled to the multicore memories 160. A high throughput network security system includes one or more network security engines 110, where each network security engine 110 includes a core engine 140, engine memories 145, input module 120 and output module 130. Core engine 140 is coupled to the processing controller and may also be coupled to multicore memories 160. Processing controller 170 may be coupled to engine memories 145. Multicore memories 160 are coupled to engine memories 145 such that memory access can be carried out using mechanisms such as direct memory access (DMA). The throughput of a network security system is typically the amount of data that can flow through the system over a given time period.

The network security system receives a received input data 101, such as data from the network, that is passed to the network security engine 110 for processing. The network security engine 110 performs security processing on the received input data and produces processed output data 104 that is sent back to the network security system.

Input module 120 within the network security engine 110 receives the received input data 101 and produces a first intermediate data 102. First intermediate data 102 is then passed on to core engine 140 via engine memories 145. The core engine 140 performs security functions using the first intermediate data 102 to produce a first output data 103 that is passed on to an output module 130, via the Engine Memories 145. The core engine 140 is configured to operate the multicore processing module 150 to perform one or more security functions. Said security functions are selected from a list comprising at least: pattern matching operations, regular expression matching operations, string literal matching operations, decoding operations, encoding operations, compression operations, decompression operations, encryption operations, decryptions operations, and hashing operations. Merely by way of example, input module 120 may receive an e-mail message and perform Base64 decoding to extract textual data, which is represented by first intermediate data 102.

As FIG. 1 illustrates, core engine data are transferred between core engine 140 and engine memories 145. Core engine data is a composite set of data that includes other data such as, first intermediate data, scheduled data, and channel results, described below.

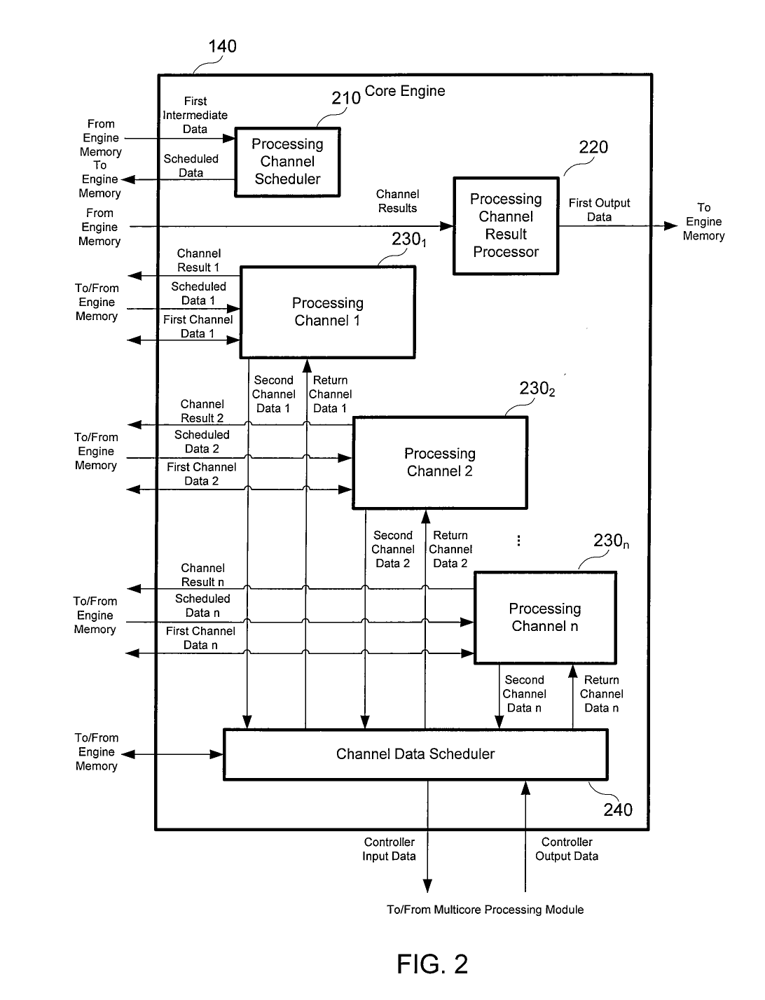

In one embodiment, core engine 140 includes a processing channel scheduler 210, a plurality of processing channels 230, a processing channel result processor 220 and a channel data scheduler 240, as shown in FIG. 2. The first processing channel is referred to as processing channel 1 2301, the second processing channel is referred to as processing channel 2 2302, and so on and so forth up to the last processing channel, which is referred to as processing channel n 230ₙ. The processing channels are collectively referred to as processing channels 230. In this embodiment, the processing performed by core engine 140 includes receiving and passing the first intermediate data to the processing channel scheduler 210. Processing channel scheduler 210 then processes the first intermediate data to produce one or more scheduled data. Processing channel scheduler 210 may produce multiple scheduled data, up to one scheduled data per processing channel. Merely by way of example, processing channel scheduler 210 may receive a decoded e-mail message as a first intermediate data 102; process the e-mail message to extract header and body parts; and transmit the header parts as scheduled data 1 and the body parts as scheduled data 2. Each scheduled data is transmitted to a corresponding processing channel, possibly via engine memories 145.

Processing channels 230 operate in collaboration with the multicore processing module 150 to perform at least part of a security function. In one embodiment, a part of a security function may be the pattern matching operation of an overall scanning process for malware signatures in an e-mail message. In this case, the steps of the scanning process typically include, but are not limited to:
1. Receiving an e-mail message.
2. Decoding the message to extract textual data.
3. Performing pattern matching using a database of malware signatures.
4. Receiving pattern matching results that include the malware signatures that matched and the locations within the e-mail message that contain malware signatures.
5. Performing extra operations to verify that the found locations indeed contain malware.
6. Quarantining the e-mail message if it contains malware.

In steps 3 and 4 the just-described scanning process, processing channels 230 and multicore processing module 150 operate in co-operation to perform pattern matching operations. Step 1 of the scanning process may be performed by a network security system.

Step 2 may be performed by input module 120. Step 5 may be performed by processing channel result processor 220 (described below) and step 6 may be performed by the network security system.

Steps 3, 4 and 5 may be performed by carrying out the following more detailed steps:
1. Providing a database of compiled malware signatures to the multicore processing module 150. This is required if such a database has not already been provided to the multicore processing module 150 or an updated database is required.
2. Deriving scheduled data from at least a part of the first intermediate data 102. Merely by way of example, scheduled data may be the body part of an e-mail message, where the first intermediate data 102 is a decoded and complete e-mail message. In this example, scheduled data may be derived by detecting the location of a blank line, then extracting all text after the blank line to create the extracted body part of the e-mail message.
3. Generating a first channel data and second channel data from the scheduled data. Merely by way of example, the first channel data may be the same as the scheduled data. In another example, a plurality of first channel data may be generated for each scheduled data, where each first channel data is a sub-segment of the scheduled data. In such an embodiment, the scheduled data is broken up into packets of data that are individually processed, possibly by a multicore processing module 150. In general, first channel data are placed in engine memories 145, which are then made available to the multicore processing module 150 through the operation of memory access mechanisms, such as direct memory access (DMA). Note that extraction of first channel data may be performed by creating references to the original copy of the data, using memory pointers or other techniques familiar to those skilled in the art.
4. Transmitting second channel data to a channel data scheduler 240. The channel data scheduler 240 receives second channel data from each processing channel 230. The channel data scheduler 240 then generates instructions and commands in the form of controller input data that are transmitted to the multicore processing module 150. Signals and results are received back from the multicore processing module 150 in the form of controller output data and result data that has been transferred to engine memories 145, through mechanisms such as DMA. In one embodiment, the channel data scheduler 240 is further configured to receive second channel data and break the second channel data stored in engine memories 145 into packets of data that are individually processed, possibly at some stage by a multicore processing module 150.
5. Operating the multicore processing module 150 to perform at least part of a security function. The multicore processing module 150 being configured to perform pattern matching operations. First channel data are processed by at least one thread of execution that executes on at least one processing core 180. One thread of execution may operate on more than one first channel data. As a result of operation, the multicore processing module 150 produces match events that relate to the result of performing matching on scheduled data, such matching being against the database of compiled malware signatures. Match events include data that relate to the match, such as a data element identifying the signature that matched, and the location of the match within the first channel data or scheduled data.
6. Receiving a plurality of match events from the multicore processing module 150. The match event data may be transferred to engine memories 145 from multicore memories 160 using DMA transfers. Signals may be received back from the multicore processing module 150 at the channel data scheduler 240. The signals may include notifications of the completion of the processing of a block of data by the multicore processing module 150.
7. Receiving return channel data from channel data scheduler 240, such channel data including channel specific results obtained from operating the multicore processing module 150.
8. Transmitting the return channel data to the processing channel result processor 220 as channel results. The processing channel result processor 220 performs at least part of a security function on the received channel results. Merely by way of example, the processing channel result processor 220 may perform extra operations to verify that the locations in the channel results do indeed contain malware. Processing channel result processor 220 generates a first output data from the channel results.
9. Transmitting the first output data to the network security system.

Processing of the first channel data may involve identifying smaller groups of data in the first channel data and transmitting these smaller groups of data to the multicore processing module 150 over multiple transmissions, possibly via engine memories 145. The channel data scheduler 240 generates a controller input data that is transmitted to, and controls, the operation of the multicore processing module 150.

In one embodiment, the multicore processing module 150 exposes a logical interface that incorporates the concept of stream processing. An example of such an embodiment is one in which the multicore processing module 150 is a graphics processing unit (GPU). In such an embodiment, a processing stream is associated with the processing of a fragment, also known in the art as a potential output pixel, to generate an output pixel. In standard GPU operation, each fragment is associated with a set of data, such as, texture coordinates, position and color. The processing of a fragment is carried out by a pixel shader. The data associated with a fragment may be in part generated by a vertex shader, and in part fetched from multicore memories 160. In this example, multicore memories 160 hold input and output data for the processing cores, this data being represented in the form of texture data. The texture data are transferred to and from engine memories 145. In addition to input data, compiled malware signature databases may also be stored in the form of texture data. Therefore, data to be processed by each processing channel 230 may be fed into the multicore processing module 150 as a fragment whose initial value is obtained from texture memory stored in multicore memories 160. The fragments are processed by one or more pixel shaders to produce an output pixel value, which becomes an output value of the corresponding stream processing operation of the multicore processing module 150. In this embodiment, the processing performed by the pixel processor may be the operations of a pattern matching engine, the instructions for implementing the pattern matching engine being contained in the instructions included in the controller input data. Merely by way of example, controller input data may be vertex and pixel shader program instructions that control the operation of the processing cores 180 to perform network security functions, such as pattern matching. Controller input data may also include other data, such as: instructions to initialize the multicore processing module 150; instructions to load vertex and pixel shader instructions; instructions to bind parameters and compiled shader programs; instructions to change input data source and destinations; any combinations of these; and the like. In this example embodiment, processing cores 180 are the pixel and vertex shaders of the GPU. Note, these vertex and pixel shaders are also respectively referred to as vertex and pixel processors.

In one embodiment, the multicore processing module 150 is configured to perform pattern matching based security functions. In this embodiment, the multicore processing module 150 is referred to as a pattern matching system. A pattern matching system may be implemented using apparatuses and methods disclosed in U.S. Pat. No. 7,082,044, entitled “Apparatus and Method for Memory Efficient, Programmable, Pattern Matching Finite State Machine Hardware”; U.S. application Ser. No. 10/850,978, entitled “Apparatus and Method for Large Hardware Finite State Machine with Embedded Equivalence Classes”; U.S. application Ser. No. 10/850,979, entitled “Efficient Representation of State Transition Tables”; U.S. application Ser. No. 11/326,131, entitled “Fast Pattern Matching Using Large Compressed Databases”; U.S. application Ser. No. 11/326,123, entitled “Compression Algorithm for Generating Compressed Databases”, the contents of all of which are incorporated herein by reference in their entirety.

Merely by way of example, the pattern matching system implemented by the multicore processing module 150 may be based on a finite state machine, such as the Moore finite state machine (FSM) as known to those trained in the art. Typically, operating such a finite state machine involves performing, for each input symbol, the following steps.
1. Receiving an input symbol;
2. Reading the current state from the current state memory table;
3. Performing a first set of logic operations using the input symbol and the current state;
4. Performing a memory lookup of a first memory table;
5. Feeding data retrieved from the first memory lookup back to the first set of logic operations; and
6. Performing a second set of logic operations.
7. Calculating and storing the new state in the current state memory table;
8. Transmitting the output result to an output memory table;

Operating a finite state machine may require the use of multiple memory lookups. Operating a finite state machine in such a way requires the following steps.
1. Receiving an input symbol;
2. Reading the current state from the current state memory table;
3. Performing a first set of logic operations using the input symbol and the current state;
4. Performing a memory lookup of a first memory table;
5. Performing a second set of logic operations;
6. Performing a memory lookup of a second memory table;
7. Feeding data retrieved from the second memory lookup back to at least one of the previous sets of logic operations; and
8. Performing a third set of logic operations.
9. Calculating and storing the new state in the current state memory table;
10. Transmitting the output result to an output memory table;

The above steps apply to each received input symbol. Furthermore, the above steps can be generalized to a finite state machine that requires m memory lookups. For such machines, the operating steps are.
1. Receiving an input symbol;
2. Reading the current state from the current state memory table;
3. Performing a first set of logic operations using the input symbol and the current state;
4. Performing a memory lookup of a first memory table;
5. Performing a second set of logic operations;
6. Performing a memory lookup of a second memory table;
7 . . . .
8. Performing an m-th set of logic operations;
9. Performing a memory lookup of an m-th memory table;
10. Feeding data retrieved from the m-th memory lookup back to at least one of the previous sets of logic operations; and
11. Performing a (m+1)-th set of logic operations.
12. Calculating and storing the new state in the current state memory table;
13. Transmitting the output result to an output memory table;

The three sets of steps described above for operating an FSM assume that the memory tables have been pre-configured with the appropriate data for the state machine.

In one implementation of an m memory lookup FSM using a multicore processing module, areas of the multicore memories 160 are logically or physically assigned to each of the m memory tables. In such an implementation an area of the multicore memories 160 is assigned to hold input symbols; one or more input symbols are mapped to data from one or more processing channels 230. As input symbols are repetitively consumed by the FSM, the core engine operates to keep the supply of input symbols flowing into the multicore processing module. Note: if not enough input symbols are made available to the multicore processing module 150, the multicore processing module stalls operations until it receives more input symbols.

Merely by way of example, when the multicore processing module 150 is a graphics processing unit, multiple input symbols may be packed into a single four-component value. A four-component value is typically used to represent a pixel value consisting of the Red, Green, Blue and Alpha (RGBA) components. If each component is a 32-bit floating value, then it is possible to pack at least two 8-bit symbols into each component. For example a component, C, representing one of the RGBA components, can be used to represent two 8-bit symbols, a and b, where C=256.0×a+b.

In one implementation of an m memory lookup FSM using a multicore processing module, an area of the multicore memories 160 is assigned to hold output results from the processing cores 180. The network security engine 110 is responsible for regularly retrieving output results and placing them in engine memories 145. In some embodiments, if the allocated space for output results in the multicore memories 160 is exhausted, the multicore processing module 150 stalls operations until more output result space becomes available. In other embodiments, operation of the multicore processing module 150 may be maintained whilst output result space is exhausted; in such an embodiment results are lost during the period in which the output result space remains exhausted.

Logic operations required by the FSM may be implemented using the operations provided in the processing cores 180. In various embodiments of the invention, the operations used by the processing cores include: Floating point operations, Integer operations, Mathematical operations, Bit operations, Branching operations, Loop operations, Logic operations, Transcendental function operations, Memory read operations, and Memory write operations. If some logic operations, such as bit operations, are not available on the processing cores 180, then other operations may be used in combination to achieve a similar effect. Merely by way of example, if processing cores 180 only provide floating point operations, and a bit operation of shifting left by one position is required on an operand, then an equivalent operation is to multiply the operand by 2.0.

Many embodiments of multicore processing modules 150 comprise relatively high latency, large capacity, high bandwidth multicore memories 160. Examples of multicore memories 160 include DDR3 DRAM and DDR4 DRAM. Example capacities of multicore memories 160 are 512 MB and 1 GB. DRAMs have a relatively high latency when compared to SRAMs. In embodiments using DRAMs, the relatively high latency of DRAMs combined with the complex operations performed by each thread of execution mean that in order to achieve high throughput rates, a large number of threads need to be executed in parallel. Therefore, in order to obtain high throughput rates of an FSM implemented in the multicore processing module 150, it is essential to have enough parallel data to process and enough threads of execution to maximize the utilization of the processing cores 180. This means that it is essential for the core engine 140 to parallelize the operations performed on the first intermediate data 102. One way of achieving this goal is to use enough processing channels 230 in the core engine 140 where first intermediate data are scheduled and parallelized for processing on each processing channel 230. Data scheduled for processing on processing channels 230 maps to data elements stored in multicore memories 160 that are scheduled for processing on processing cores 180. Therefore, processing channels 230, and the like, may be used to provide the parallelism required by multicore processing modules 150 for performing high throughput network security functions. Examples of multicore processing modules 150 possessing the just-described properties are GPUs and stream processing devices. Stream processing devices are typically co-processors to CPU-based host systems. These devices are used to accelerate computationally expensive operations. Consequently, stream processing devices may be used to perform network security functions.

To clarify, a thread of execution is a logical independent flow of execution of a set of instructions. Threads of execution are represented by a set of parameters that determine the state of a thread. Each thread of execution may operate on one or more data elements stored in multicore memories 160. Processing controller 170 operates to schedule a data element stored in multicore memories 160 for processing on a thread of execution. In some embodiments, the number of threads of execution is the same as the number of processing cores 180. In one embodiment the number of threads of execution is equal to the number of data elements to be processed. In one embodiment, the number of threads of execution is somewhere between the number of processing cores and the number of data elements to process. In one embodiment, the number of threads of execution is reconfigurable.

In many embodiments, threads of execution in multicore processing module 150 operate over a group of data elements stored in multicore memories 160, these threads being scheduled by processing controller 170. Multiple groups of data elements are processed over multiple processing iterations. One processing iteration is deemed complete when all data elements in this group have been processed. In one processing iteration, all data elements in a group of data elements are processed, or at least considered for processing. It is not necessary that each data element in the group be processed, but each data element must be evaluated for processing. This situation arises if conditional processing is used, where processing is bypassed based on a set of logical conditions. The order of processing of data elements in a group of data elements is typically not guaranteed. Instead, the data elements may be processed in any order and with any degree of parallelism. Data in a group of data elements being scheduled for processing on processing cores 180 during any one processing iteration may be referred to as parallel data elements. In the context of the above described FSM example, a group of data elements is the group of input symbols transmitted to the multicore memories 160. When the multicore processing module 150 is a GPU, a processing iteration is the processing of one frame of pixels.

In one embodiment, one of the tasks performed by processing channel scheduler 210 (shown in FIG. 2) is the creation of scheduled data to be processed by the multicore processing modules 150 over successive processing iterations, where each iteration involves the processing cores 180 performing network security functions. In some embodiments, multiple processing iterations may be carried out on the multicore processing module 150, output data being generated in each iteration and stored in multicore memories 160, before being read back by the network security engine 110. Note that the output data may be further processed over one or more processing iterations, possibly using a different set of processing core instructions, before the data is read back by the network security engine 110.

In some embodiments, the output results from the processing cores 180 are further processed to reduce the number of output results. Merely by way of example, in some embodiments not all threads of execution implementing a pattern matching FSM will produce a ‘match’ signal for every input symbol. Therefore, the output result for these threads of execution may be suppressed and not sent back to the network security engine 110. Doing so reduces the amount of data that needs to be transferred back to the network security engine 110, and thus potentially increases overall throughput rates.

Merely by way of example, a specific implementation of a one memory table FSM where the multicore processing module 150 is a graphics processing unit includes the following steps:
1. Initializing the graphics system.
2. Initializing the vertex buffer, target textures that hold output results, input textures that hold static input data of databases (such as the contents of the memory tables for the FSM), input textures to hold received input data, and vertices for the vertex processor.
3. Binding and initializing parameters for the vertex and pixel shaders; creating and loading a simple vertex shader that creates a quadrangle; and creating and loading pixel shaders that contain code for implementing a single memory lookup FSM.
4. Looping over all available sets of received input data:
   a. Updating input texture to contain the next set of received input data.
   b. Updating input state texture and destination state texture locations. Note: an input state texture becomes the destination state texture for the next iteration and vice-versa. This is done so that one texture serves to hold the current input states of the FSM and the other texture serves to hold the output states of the FSM. The contexts of these textures are swapped each iteration.
   c. Binding shader programs.
   d. Performing a draw function.
   e. Operating the vertex and pixel processors, where the vertex processor creates the corners for the quadrangle, and the pixel processor performs the steps of:
      i. Looping over all received input data that has been loaded into multicore memories 160 and for each thread of execution, performing the following steps:
         1. Reading the current state from the input state texture.
         2. Reading the current input symbol from the input texture, or a temporary register containing a set of pre-fetched input symbols.
         3. Combining the current input symbol with the current state to calculate an address into the memory table.
         4. Retrieving the contents of the memory table at the calculated address.
         5. Deriving the next state from the contents read from the memory table.
         6. Storing the next state value in a register.
         7. Outputting results to a register.
      ii. Storing next state value in the destination state texture.
      iii. Storing output results in an output texture.
   f. Retrieving results from the destination state texture and output texture.
   g. Performing further network security function operations on the results in the processing channels 230.
5. Performing further network security function operations on the overall results.

In the above example, the instructions for the vertex and pixel processors can be written in the Cg programming language. Alternatively, the HLSL shading language can be used in place of Cg, or used in combination with Cg. In all cases, OpenGL or DirectX can be used to create the infrastructure required to compile and load the vertex and pixel shader programs. Typically, OpenGL and DirectX are used to set up the graphics system, loading and updating the textures. GPU vendors may also provide further application programming interfaces (API) that provide alternative ways of operating the GPU. Such APIs facilitate access to low-level functionalities of the GPU without reference to graphics functions. Other such APIs allow programmers to write high-level code without reference to graphics functions.

Merely by way of example, a general implementation of a one memory table FSM using multicore processing module 150 includes the following steps:
1. Initializing the multicore processing module 150.
2. Initializing the multicore memories 160 to hold output results, databases (such as the contents of the memory tables for the FSM), and received input data.
3. Creating and loading the instructions for the processing cores 180, where the instructions include code for implementing an FSM, such as one that uses one memory tables.
4. Looping over all available sets of received input data:
   a. Updating multicore memories 160 to contain the next set of received input data.
   b. Updating input state and destination state locations. An input state becomes the destination state for the next iteration and vice-versa. This is done so that one part of multicore memories 160 hold the current input states of the FSM and another part of multicore memories 160 hold the output states of the FSM. The contexts of these memories may be swapped on each iteration.
   c. Loading the instructions for the processing cores 180 if such instructions have not already been loaded.
   d. Notifying the processing controller 170 to execute the processing cores 180 using threads of execution over parallel data elements stored in multicore memories 160.
   e. Operating the processing cores 180 to perform the steps of:
      i. Looping over all received input data that has been loaded into multicore memories 160 and for each thread of execution, performing the following steps:
         1. Reading the current state from the input state part of multicore memories 160.
         2. Reading the current input symbol from the input part of multicore memories 160, or a temporary register containing a set of pre-fetched input symbols.
         3. Combining the current input symbol with the current state to calculate an address into the memory table of the FSM stored in the multicore memories 160.
         4. Retrieving the contents of the memory table at the calculated address.
         5. Deriving the next state from the contents read from the memory table.
         6. Storing the next state value in a register.
         7. Outputting results to a register.
      ii. Storing next state value in the destination state part of multicore memories 160.
      iii. Storing output results in an output part of multicore memories 160.
   f. Retrieving results from the destination state and output parts of multicore memories 160.
   g. Performing further network security function operations on the results in the processing channels 230.
5. Performing further network security function operations on the overall results.

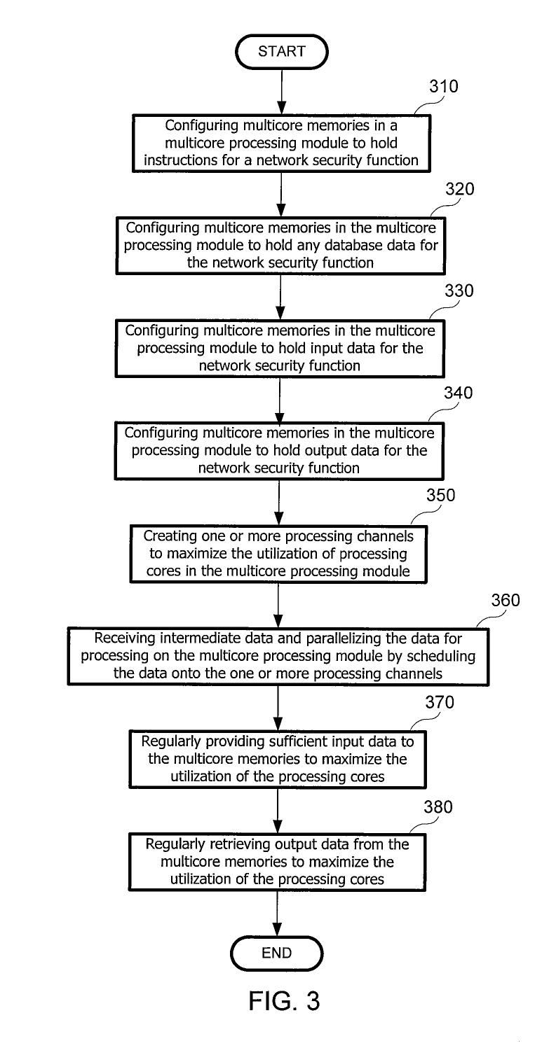

The flowchart in FIG. 3 illustrates the general steps required to operate a multicore processing module 150 to perform network security functions at high throughput rates. The process includes the steps of:
1. Configuring the multicore memories 160 to hold instructions for a specific network security function (step 310);
2. Configuring the multicore memories 160 to hold any database data for a specific network security function (step 320);
3. Configuring the multicore memories 160 to hold input data for the specific network security function (step 330);
4. Configuring the multicore memories 160 to hold output data for the specific network security function (step 340);
5. Creating enough processing channels 230 to maximize the utilization of the processing cores 180 (step 350).
6. Receiving first intermediate data at the core engine 140 and parallelizing the data for processing on the multicore processing module 150 by scheduling the data onto one or more processing channels 230 (step 360).
7. Operating the core engine 140 to regularly provide sufficient input data to the multicore memories 160 to maximize the utilization of the processing cores 180 (step 370).
8. Operating the core engine 140 to regularly retrieve output data from the multicore memories 160 to maximize the utilization of the processing cores 180 (step 380).

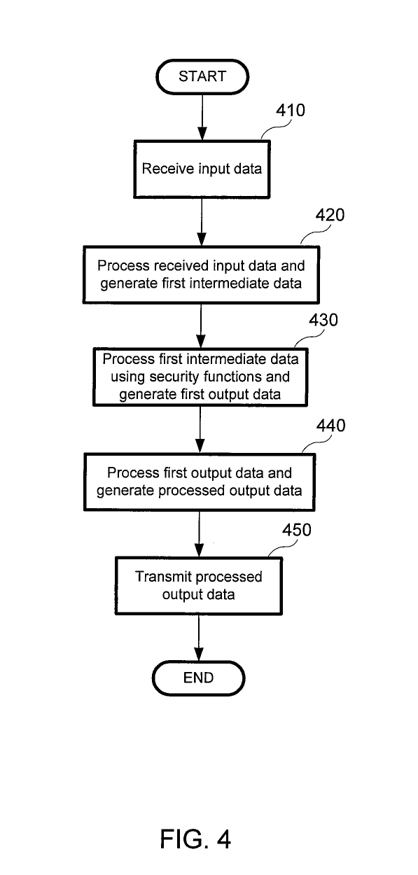

FIG. 4 illustrates the flowchart of the process of operating a network security engine at high throughput rates. The process starts with receiving input data in step 410. Step 420 involves processing the received input and generating a first intermediate data. In step 430, the first intermediate data is processed using security functions to generate a first output data. The first output data is processed and used to generate output data in step 440. The final step (step 450) transmits the processed output data.

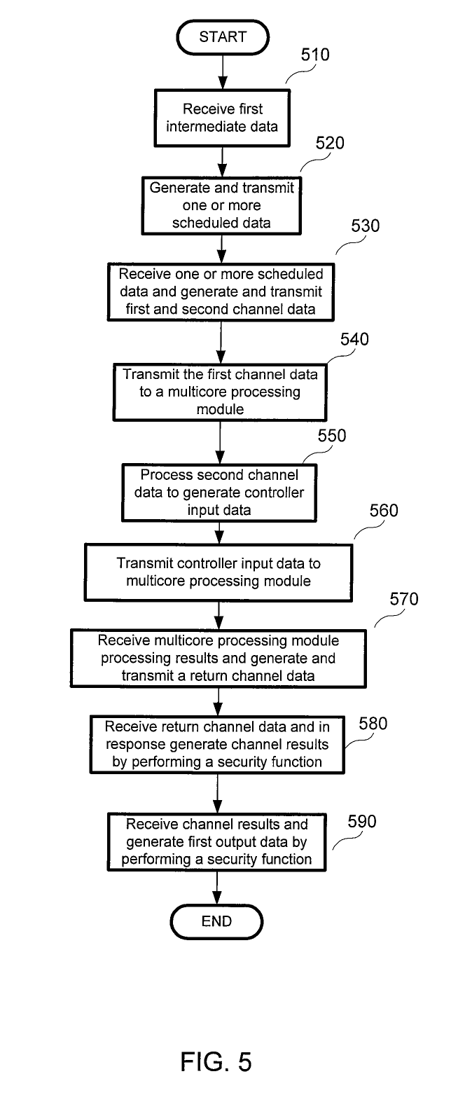

Step 430 is decomposed into more detailed steps in the flowchart in FIG. 5. The flowchart in FIG. 5 starts with receiving the first intermediate data in step 510. Step 520 involves using the first intermediate data to generate and transmit one or more scheduled data. In step 530, the one or more scheduled data are received and used to generate and transmit a first and second channel data. In step 540, the first channel data are transmitted to a multicore processing module for further network security processing. The second channel data are processed to generate controller input data in step 550. The controller input data is used to control the operation of the multicore processing module. The controller input data is transmitted to the multicore processing module in step 560 to control the processing of the first channel data. In step 570, the results from operating the multicore processing module are received and used to generate and transmit a return channel data. Return channel data are then received and used to generate channel results by performing a security function (step 580). The final step (step 590) receives channel results and generates a first output data by performing a security function.

In one embodiment, the network security system 110 can be applied to the processing of network packets, where network packets are scanned for malicious payload. Network packets with malicious payload are dropped. In this case, received input data are network data packets. First intermediate data may be the payload of each packet. Processing channel scheduler 210 then schedules the payload of each network stream to a processing channel 230, where there may be as many processing channels as there are network streams. Merely by way of example, the number of active network streams may be in the tens of thousands.

In one embodiment, the processing channel scheduler 210 breaks up a logical and contextual group of first intermediate data into multiple and independent packets of data. The independence of the packets of data implies that each packet can be processed by a separate and concurrent processing channel 230, thus the data scheduled for processing in each processing channel 230 may be mapped to data elements stored in multicore memories 160 that are scheduled for processing on processing cores 180. This embodiment is useful when there are significantly fewer logical and contextual groups of first intermediate data compared with the number of parallel data elements required to maximize the utilization of the processing cores 180. Merely by way of example, the network security system 110 is configured to receive e-mail messages on 200 streams. To maximize the utilization of the processing cores 180, up to 10000 parallel data elements on the multicore processing module 150 are required. Using this embodiment, the e-mail messages on each stream are broken up into 100 byte packets. So, for example, a 10 kB e-mail message is segmented into 100 packets. Each packet is then scheduled onto a processing channel 210. There are as many processing channels 210 as there are data elements scheduled for parallel processing on the multicore processing module 150. Each packet is processed independently, and the results from processing each packet are then further processed, by either the processing channel 210 or the processing channel result processor 220, to obtain a combined result for each stream.

Processing controller 170 includes logic to implement a processing time allocation algorithm. The processing controller 170 maintains relevant information for each thread of execution. The processing time allocation algorithm is used to schedule each thread of execution a slice of processing time on a processing core 180. Merely by way of example, a slice of processing time may be: all the processing time required by a thread of execution; the time required to execute one complete iteration of a block of instructions stored in multicore memories 160; or the time required to execute a part of a block of instructions stored in multicore memories 160, the thread of execution then being pre-emptively re-scheduled for processing at a later point in time by the processing controller 170. The processing time allocation algorithm is used to maximize the utilization of the processing cores 180. The processing controller 170 can also be referred to as a command processor; it functions as scheduler for the processing cores 180. In one embodiment, processing controller 170 is configured to have access to engine memories 145; such access includes reading and writing elements in engine memories 145.

In one embodiment, core engine 140 is configured to access multicore memories 160. In such an embodiment core engine 140 can store and retrieve elements of multicore memories 160. This configuration may be used to set and retrieve parameters and data values that are used by processing cores 180.

In some embodiments processing cores 180 include parallel arrays of processors, where each processor can access data in multicore memories 160, such as textures in a GPU, and write to one or more outputs, such as render targets and conditional buffers in a GPU. In one embodiment, processing cores 180 is also configured to have access to engine memories 145, where access includes reading and writing to elements in engine memories 145. In one embodiment, processing cores 180 may be further configured to perform multiple instructions in parallel. For example, in one embodiment ALU instructions on a 4-way multicore CPU are carried out in parallel with accesses to multicore memories 160 and/or engine memories 145. Other instructions that may be carried out in parallel include flow control functions, such as branching.

In some embodiments, multicore memories 160 may include a memory controller that controls reads and writes to areas in the memory. In these embodiments, all accesses to the multicore memories 160 are managed by the memory controller. Multicore memories 160 also include caches and registers. Multicore memories 160 may be used to store commands, instructions, constants, input and output values for the processing controller 170 and processing cores 180. In some embodiments, multicore memories 160 include content addressable memories (CAM), ternary content addressable memories (TCAM), Reduced Latency DRAM (RLDRAM), synchronous DRAM (SDRAM), and/or static RAM (SRAM).

In some embodiments, engine memories 145 may include a memory controller that manages access to its memories. In these embodiments, direct memory access (DMA) transfers may occur between engine memories 145 and multicore memories 160.

In one embodiment, the network security engine 110 is coupled to the multicore processing module 150 via a PCI-Express interface. Other examples of coupling interfaces include HyperTransport. In some embodiments, other entities may exist between the coupling of the network security engine 110 to the multicore processing module 150. Examples of such entities include device drivers and software APIs.

In one embodiment, the multicore processing module 150 is an integrated circuit with reconfigurable hardware logic. The reconfigurable hardware logic includes devices such as field programmable gate arrays (FPGA).

The above embodiments of the present invention are illustrative and not limitative. Various alternatives and equivalents are possible. For example, the invention is not limited by the type of processing circuit, GPU, CPU, ASIC, FPGA, etc. that may be used to perform the present invention. The invention is not limited to any specific type of process technology, e.g., CMOS, Bipolar, or BICMOS that may be used to manufacture the present disclosure. Other additions, subtractions or modifications are obvious in view of the present disclosure and are intended to fall within the scope of the appended claims.

What is claimed is:

1. An accelerated network security system comprising:
a network security engine comprising:
an input module configured to receive input data and generate a first intermediate data in response;
a core engine configured to perform a security function operation on the first intermediate data to generate a first output data; and
an output module configured to receive the first output data and generate a processed output data in response; and
a processing module configured to perform the security function, the processing module comprising:
a plurality of processing cores configured to operate concurrently;
a memory configured to store data associated with the plurality of processing cores, wherein the data stored in the memory includes processing core instructions and processing core data, wherein the processing core instructions control the execution of the plurality of processing cores to implement the security function; and
a processing controller configured to periodically allocate to each processing core one or more discrete blocks of processing time, each processing of each portion of core data representing at least one execution thread, wherein the periodic allocation of processing time is performed according to a processing time allocation algorithm, wherein a number of processing core data is greater than a number of the plurality of processing cores.

2. The system of claim 1 wherein the core engine is configured to perform a security function on the first intermediate data using one or more processing channels, wherein each of the one or more processing channels is configured to use the processing module to perform at least part of the security function.

3. The system of claim 2 wherein the one or more processing channels use the processing module via at least a channel data scheduler.

4. The system of claim 1 wherein the processing module is an integrated circuit comprising a graphics processing unit.

5. The system of claim 1 wherein the processing module is a stream processing device.

6. The system of claim 1 wherein the processing time allocation algorithm maximizes amount of data that is transferred between the plurality of processing cores and the memory over a given time period.

7. The system of claim 1 wherein the processing time allocation algorithm maximizes utilization of the plurality of processing cores.

8. The system of claim 1 wherein the processing module comprises at least four processing cores.

9. The system of claim 1 wherein the plurality of processing cores include pixel shaders in a graphics processing unit.

10. The system of claim 1 wherein the plurality of processing cores include vertex shaders in a graphics processing unit.

11. The system of claim 1 wherein the plurality of processing cores are disposed in a central processing unit.

12. The system of claim 1 wherein the core engine is configured to perform at least one security function selected from a group of security functions consisting of Pattern matching operations, Regular expression matching operations, String literal matching operations, Decoding operations, Encoding operations, Compression operations, Decompression operations, Encryption operations, Decryption operations, and Hashing operations.

13. The system of claim 12 wherein the plurality of processing cores are configured to perform at least one operation selected from a group of operations consisting of Floating point operations, Integer operations, Mathematical operations, Bit operations, Branching operations, Loop operations, Logic operations, Transcendental function operations, Memory read operations, and Memory write operations.

14. The system of claim 12 wherein the at least one of the plurality of processing cores comprise an arithmetic logic unit.

15. A method for operating network security engines at high throughput rates, the method comprising:
receiving input data;
processing the received input data to generate an intermediate data;
processing the intermediate data to generate a first output data by performing a security function using a processing module configured to perform the security function, the processing module comprising:
a plurality of processing cores configured to operate concurrently;
a memory configured to store data associated with the plurality of processing cores, wherein the data stored in the memory includes processing core instructions and processing core data, wherein the processing core instructions control the execution of the plurality of processing cores to implement the security function; and
a processing controller configured to periodically allocate to each processing core one or more discrete blocks of processing time, each processing of each portion of core data representing at least one execution thread, wherein the periodic allocation of processing time is performed according to a processing time allocation algorithm, wherein a number of processing core data is greater than a number of the plurality of processing cores.
processing the first output data to generate a processed output data; and
transmitting the processed output data.

16. The method of claim 15 wherein the steps of processing the first input data to generate the first output data further comprises:
generating one or more scheduled data in response to the intermediate data;
transmitting the one or more scheduled data;
generating and transmitting a first channel data and a second channel data in response to receiving the one or more scheduled data;
transmitting the first channel data to the processing module;
processing the second channel data to generate a controller input data;
transmitting the controller input data to the processing module;
performing a security function on the processing module;
generating and transmitting a return channel data in response to receiving output of the processing module;
generating channel results in response to the return channel data; and
generating the output data in response to the channel results by performing a security function.

17. The method of claim 15 wherein the processing module is an integrated circuit comprising a graphics processing unit.

18. The method of claim 15 wherein the processing module is a stream processing device.

19. The method of claim 15 wherein the processing time allocation algorithm maximizes an amount of data transferred between the plurality of processing cores and the memory over a given time period.

20. The method of claim 15 wherein the processing time allocation algorithm maximizes utilization of the plurality of processing cores.

21. The method of claim 15 wherein the processing module comprises at least four processing cores.

22. The method of claim 15 wherein the plurality of processing cores include pixel shaders disposed in a graphics processing unit.

23. The method of claim 15 wherein the plurality of processing cores include vertex shaders in a graphics processing unit.

24. The method of claim 15 wherein the plurality of processing cores are disposed in a central processing unit.

25. The method of claim 15 wherein the security function is selected from a group consisting of Pattern matching operations, Regular expression matching operations, String literal matching operations, Decoding operations, Encoding operations, Compression operations, Decompression operations, Encryption operations, Decryption operations, and Hashing operations.

26. The method of claim 25 wherein the plurality of processing cores are configured to perform at least one operation selected from a group of operations consisting of Floating point operations, Integer operations, Mathematical operations, Bit operations, Branching operations, Loop operations, Logic operations, Transcendental function operations, Memory read operations, and Memory write operations.

27. The method of claim 25 wherein at least one of the plurality of processing cores comprises an arithmetic logic unit.
